(19) United States
(12) Patent Application Publication
(10) Pub. No.: US 2008/0097981 A1
(43) Pub. Date: Apr. 24, 2008

(54) RANKING IMAGES FOR WEB IMAGE RETRIEVAL

(75) Inventors: HUGH J. WILLIAMS, REDMOND, WA (US); NICK CRASWELL, CAMBRIDGE (GB); NICHOLAS A. WHYTE, MERCER ISLAND, WA (US); JULIE H. FARAGO, SEATTLE, WA (US); JAMES E. WALSH, WOODINVILLE, WA (US); CARSTEN ROTHER, CAMBRIDGE (GB)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, REDMOND, WA (US)

(21) Appl. No.: 11/551,355

(22) Filed: Oct. 20, 2006

(51) Int. Cl. G06F 17/30

(52) U.S. Cl. 707/5

(57) ABSTRACT

A system, method, and computer-readable media are disclosed for providing images in a ranked order. The system can include an aggregation component for aggregating a plurality of images with corresponding text. Additionally, the system can include a name detector a name detector for detecting names within a search query. Moreover, the system can include a ranking component for ranking the aggregated images based on whether the name detector detects a name.

### CROSS-REFERENCE TO RELATED APPLICATION

Not applicable.

### STATEMENT REGARDING FEDERALLY SPONSORED RESEARCH OR DEVELOPMENT

Not applicable.

### BACKGROUND

Search engines can provide many search services to users including text, image, and video search services. Today, searches for textual content generally encompass the majority of searches performed by users. However, searches for image content are increasingly becoming popular with users as image search services are becoming more readily available.

Currently, image search technology is based on keyword search and is not based on searching for the media itself. An image is, for example, indexed by its URL and with associated text from the web page in which it appears. Search queries that match the indexed text can return the associated image as an answer, with little or no information from the image media itself being used in the querying process.

There currently does not exist sufficient methods for determining the relevance of each indexed image for a corresponding search query. Conventional methods may not take into consideration the relevancy of the text indexed with corresponding images. Additionally, conventional methods may not consider the quality of the indexed images. Accordingly, conventional methods for providing images in response to image search queries may not provide the best possible image search results to requesting users.

### SUMMARY

A system, method, and computer-readable media are disclosed for providing images in a ranked order. The computer-readable media can be configured to perform a method that includes receiving a search query having text and identifying images related to the search query. Furthermore, the performed method can include ranking the images using one or more ranking factors and providing the ranked images to a requester.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

Illustrative embodiments of the present invention are described in detail below with reference to the attached drawing figures, which are incorporated by reference herein and wherein:

FIG. 1 is a block diagram of an exemplary operating environment for implementing the invention.

FIG. 2 is a block diagram of an embodiment of a system for implementing the invention.

FIG. 3 is a flow diagram that illustrates an embodiment of a method for creating a database of images and associated text.

FIG. 4 is a flow diagram that illustrates a method for providing ranked images in response to a image search query.

### DETAILED DESCRIPTION

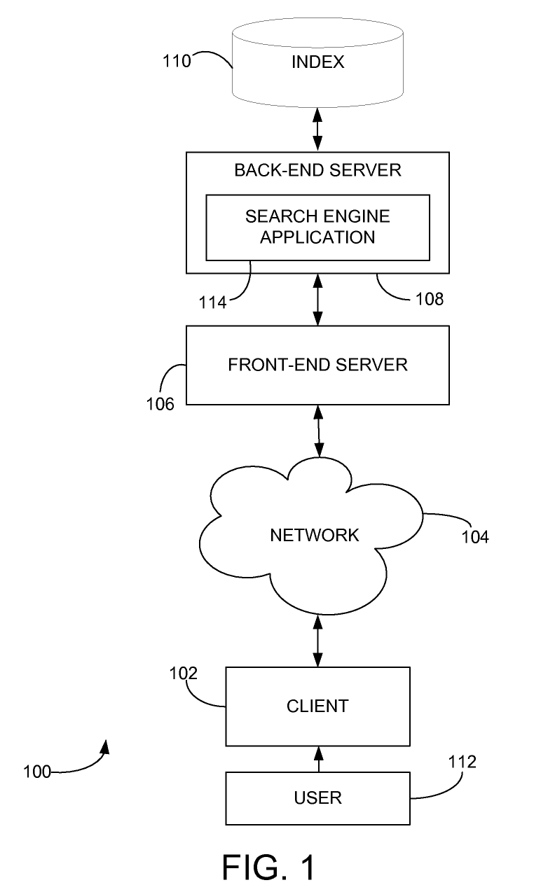

Referring initially to FIG. 1, an exemplary network environment for implementing the present invention is shown and designated generally as network environment 100. Network environment 100 is but one example of a suitable environment and is not intended to suggest any limitation as to the scope of use or functionality of the invention. Neither should the network environment 100 be interpreted as having any dependency or requirement relating to any one or combination of elements illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, specialty computing devices, servers, etc. The invention may also be practiced in distributed computing environments where tasks are performed by remote-processing devices that are linked through a communications network.

Network environment 100 includes a client 102 coupled to a network 104 via a communication interface. The communication interface may be an interface that can allow the client to be directly connected to any other device or allows the client 102 to be connected to a device over network 104. Network 104 can include, for example, a local area network (LAN), a wide area network (WAN), or the Internet (or the World Wide Web). In an embodiment, the client 102 can be connected to another device via a wireless interface through a wireless network 104.

One or more servers communicate with the client 102 via the network 104 using a protocol such as Hypertext Transfer Protocol (HTTP), a protocol commonly used on the Internet to exchange information. In the illustrated embodiment, a front-end server 106 and a back-end server 108 (e.g., web server or network server) are coupled to the network 104. The client 102 employs the network 104, the front-end server 106 and the back-end server 108 to access Web page data stored, for example, in a central data index (index) 110.

Embodiments of the invention provide searching for relevant data by permitting search results to be displayed to a user 112 in response to a user-specified search request (e.g., a search query). In one embodiment, the user 112 uses the client 102 to input a search request including one or more terms concerning a particular topic of interest for which the user 112 would like to identify relevant electronic documents (e.g., Web pages). For example, the front-end server 106 may be responsive to the client 102 for authenticating the user 112 and redirecting the request from the user 112 to the back-end server 108.

The back-end server 108 may process a submitted query using the index 110. In this manner, the back-end server 108 may retrieve data for electronic documents (i.e., search results) that may be relevant to the user. The index 110 contains information regarding electronic documents such as Web pages available via the Internet. Further, the index 110 may include a variety of other data associated with the electronic documents such as location (e.g., links, or URLs), metatags, text, and document category. In the example of FIG. 1, the network is described in the context of dispersing search results and displaying the dispersed search results to the user 112 via the client 102. Notably, although the front-end server 106 and the back-end server 108 are described as different components, it is to be understood that a single server could perform the functions of both.

A search engine application (application) 114 is executed by the back-end server 108 to identify web pages and the like (i.e., electronic documents) in response to the search request received from the client 102. More specifically, the application 114 identifies relevant documents from the index 110 that correspond to the one or more terms included in the search request and selects the most relevant web pages to be displayed to the user 112 via the client 102.

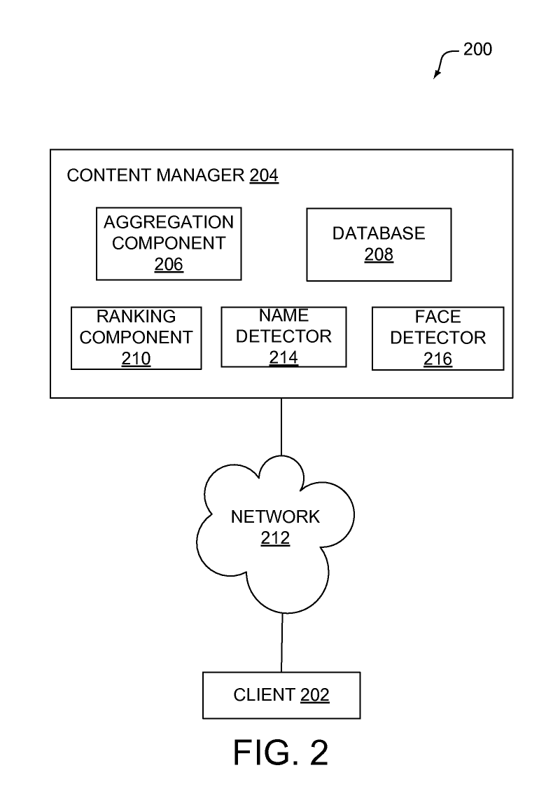

FIG. 2 is a block diagram of an embodiment of a system 200 for implementing the invention. The system can include client 202, content manager 204, and network 212. Client 202 may be or can include a desktop or laptop computer, a network-enabled cellular telephone (with or without media capturing/playback capabilities), wireless email client, or other client, machine or device to perform various tasks including Web browsing, search, electronic mail (email) and other tasks, applications and functions. Client 202 may additionally be any portable media device such as digital still camera devices, digital video cameras (with or without still image capture functionality), media players such as personal music players and personal video players, and any other portable media device. Client 202 may also be a server such as a workstation running the Microsoft Windows®, MacOS™, Unix, Linux, Xenix, IBM AIX™, Hewlett-Packard UX™, Novell Netware™, Sun Microsystems Solaris™, OS/2™, BeOS™, Mach, Apache, OpenStep™ or other operating system or platform.

Content manager 204 may be a server such as a workstation running the Microsoft Windows®, MacOS™, Unix, Linux, Xenix, IBM AIX™, Hewlett-Packard UX™, Novell Netware™, Sun Microsystems Solaris™, OS/2™, BeOS™, Mach, Apache, OpenStep™ or other operating system or platform. In an embodiment, content manager 204 may be a search engine comprising of one or more elements 106, 108, 110, 114, and 116 (FIG. 1). Content manager 204 can also include aggregation module 206, database 208, ranking component 210, and name detector 214. In an embodiment, one or more of the aggregation component 206, database 208, ranking component 210, and name detector 214 may be external components to the content manager 204. In such an embodiment, the content manager 204 can maintain access to or can control the external components.

Aggregation component 206 can be utilized to crawl web pages in order to aggregate images and text that appears on the same web pages as the images. The text can include, for example, any type of characters or symbols. Once an image and the text corresponding to the image has been identified, the aggregation component can store the images and their corresponding text in database 208. In an embodiment, database 208 is the same as index 110 (FIG. 1). In an embodiment, the text may or may not be related to the image. In another embodiment, aggregation component 206 can aggregate text that is related to an image but is found on a different web page as the image. The aggregation component 206 can be configured to associate text found on the same page as an associated image that is at any distance away from the associated image. An administrator, for example, of system 200 may determine the distance that text can be from an image in order to be associated with the image.

In an embodiment, content manger 204 can receive search requests including one or more search queries for images stored in database 208. A search query can include any text that relates to an image that a requester would like to retrieve. The content manager 204 can identify the text within the search query and can compare the text with text stored in database 208. The content manager 204 can retrieve any images that have associated text that is similar to the text within the search query. Once the images have been retrieved, ranking component 210 can be utilized to rank the retrieved images in an order of relevance to the search query. The ranking component 210 can determine the order of relevance by using one or more ranking factors for determining relevance. The ranking factors can be used to upgrade or downgrade an image's level of relevance to the search query.

Name detector 214 can be utilized to detect whether a search query includes a name of a person in it. In an embodiment, the name detector 214 can be trained to recognize different names by inputting a list of first names and last names from various name books into name detector 214. Face detector 216 may be any conventional face detector that can be utilized to detect faces in the images stored in database 208.

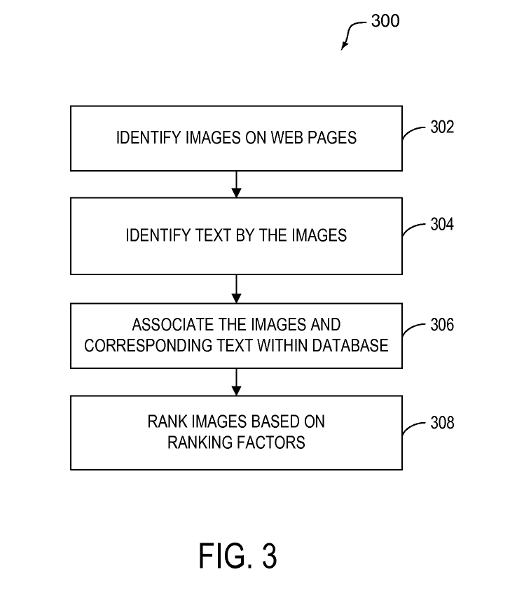

FIG. 3 is a flow diagram that illustrates an embodiment of a method 300 for creating a database of images and associated text. The method 300 further illustrates an embodiment where images are ranked as they are stored in the database. At operation 302, images are identified on a plurality of web pages. Images can be identified through any conventional means such as, for example, identifying image tags within a web page's source code. At operation 304, text that is by each image is identified. The text may or may not be related to the image. In another embodiment, the text can be found on the same page as an identified image and can be at any distance away from the identified image. In yet another embodiment, text can be identified that is related to an identified image but is found on a different web page as the identified image.

At operation 306, the identified images can be associated with their corresponding identified text within a database. At operation 308, the images within the database are ranked based on one or more ranking factors. An image's ranking can be upgraded or downgraded based on the ranking factors. Below are some ranking factors that can be employed when ranking images:

### Collecting and Using the Number of Websites that Contain an Identical Image as a Raking Factor.

One ranking factor can based on the number of websites that contain an identical image. With this ranking factor, the invention can determine that images that appear within the web pages of more than one website may be more relevant than images that appear on only one website. As such, an image's ranking can be upgraded depending on the number of websites that the image is located. In an embodiment, the invention can determine if the different websites contain an identical image by evaluating the URL of the image. If the websites point to the same URL of a particular image, then it can be determined that images are identical. In another embodiment, identical images can be determined by calculating a hash of an image. The hash value of one image can be compared to has values of other images, and if any of the hash values are the same, the images are considered to be identical. As described above, the greater the number of websites that contain identical images to the identified image, the higher the identified image is ranked. However, in another embodiment, the greater the number of websites that contain identical images to the identified image, the lower the identified image is ranked.

### Collecting and Using the Number of Websites that Contain a Similar Image as a Ranking Factor.

Another ranking factor can based on the number of websites that contain similar images. For example, an image on one website that is similar to images on other websites may receive a higher ranking depending on the greater the number of other websites that include these similar images. In an embodiment, a first image located on a first web site is similar to a second image on a second website if the second image is a modified version of the first image. For example, the first and second images are considered to be similar if the second image is a resized version (bigger or smaller) than the first image. In another example, a modified version can also include a second image that has been produced by cropping a first image, or can include a second image that has been produced by adding a border around a first image. As described above, the greater the number of websites that contain similar images to a first identified image, the higher the identified image is ranked. However, in another embodiment, the greater the number of websites that contain similar images to the identified image, the lower the identified image is ranked below other images.

### Collecting and Using the Size of Images as a Ranking Factor

Another ranking factor can be based on the size of the images. In an embodiment, the invention can be configured to determine that users are more likely to click on images with the greater number of pixels. As such, images with a greater number of pixels can be ranked higher than images with a lower number of pixels. In another embodiment, images with a greater number of pixels can be ranked lower than images with a lower number of pixels.

### Collecting and Using Link Relationships Between Images as a Ranking Factor

Another ranking factor can be based on the number of link relationships an image has with other images. In an embodiment, images with a link relationship can upgrade each other's ranking. Two images can have a link relationship if in response to accessing a first image a user would be presented with a second image. Such a link relationship can be exhibited, for example, when an image and a thumbnail size version of the image are linked together such that accessing one version of the image may lead the user to be presented with the other version of the image. As described above, the greater the number of link relationships an image has, the higher the image is ranked above other images. However, in another embodiment, the greater the number of link relationships an image has with other images, the lower the image is ranked below other images.

Using a link relationship ranking factor, images that are linked together can share each other's associated metadata that can later be used for responding to search queries. For example, suppose a thumbnail image having text nearby is linked to a larger image of the thumbnail wherein the larger image is displayed on a webpage that has no text. Each image could affect, and could possibly raise, each other's ranking. For example, the larger image's size data, a pixel count for example, can also be shared and associated with the thumbnail, and the text near the thumbnail image can also be shared and associated with the larger image. The shared metadata can be associated with each of the linked images within the database 208.

### Collecting and Using the Frequency of an Image Within a Website as a Ranking Factor

Another ranking feature can be based on the number of times an image is used within a website. For example, if a plurality of web pages within a website link to the same image (the website contains the image on more than web page within the website) or if an image is displayed a plurality of times on a web page within a website, then the invention can be configured to give the image a lower ranking than other images that are not displayed more than once on a website. The image may receive a lower ranking as the invention may determine that the image is part of the graphic design of the website rather than an important image. However, in another embodiment, an image may receive a higher ranking for the greater number of times the image is displayed within a website.

### Detecting Image Feature Levels as a Ranking Factor

Another ranking factor can be based on detecting images that do not meet or that exceed image feature levels. In an embodiment, image features may include, but are not limited to, number of pixels, aspect ratio, image file size, image entropy, and image gradient. An administrator, for example, can set threshold levels for each of the image features. In an embodiment, an image may be ranked lower if it does not meet or if it exceeds a threshold level for any of the image features. In another embodiment, an image may be ranked higher if it does not meet or if it exceeds a threshold level for any of the image features.

### Other Ranking Factors

Another ranking feature can be based on the total number of images on a webpage. For example, an image may be given a higher or lower ranking based on the number of images that are on the same web page as the image. Additionally, another ranking feature can be based on the total number of images that are linked to by a particular web page. For example, an image may be given a higher or lower ranking based on the number of images that are linked to by the same web page that the image is located. Moreover, another ranking feature can be based on the total number of thumbnail images that are located on the same webpage as the ranked image. For example, an image may be given a higher or lower ranking based on the number of thumbnail images that are located on the same page as the image. Furthermore, another ranking feature can be based on the total number of links there are to the URL of the an image. For example, an image can be given a higher ranking if it has a greater number of links to its URL compared to other images. In other embodiments, the image may be given a lower ranking if it has a greater number of links to its URL compared to other images.

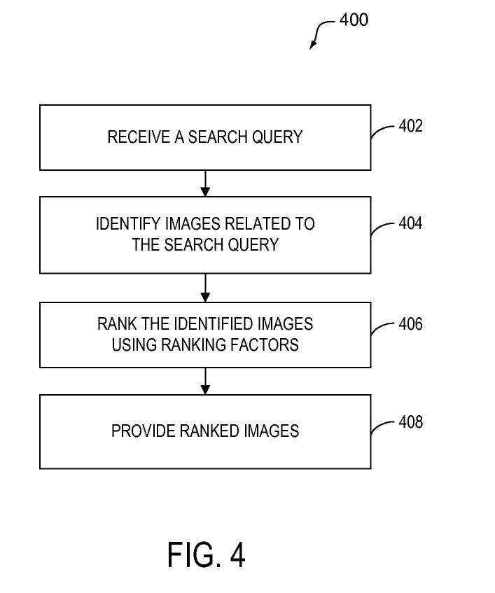

FIG. 4 is a flow diagram of a method 400 for providing ranked images in response to an image search query. The method of FIG. 4 can be configured to rank images on-the-fly as search queries are received after a database of images and associated text is created. In an embodiment, the database can be created by executing operations 302, 304, and 306 of FIG. 3. At operation 402, a search query including text is received. At operation 404, images related to the search query are identified. In an embodiment, the images are identified by comparing the text of the search query with text associated with images that are stored in the database. At operation 406, the identified images are ranked using one or more of the ranking factors described above. At operation 408, the ranked identified images can be provided to a requester. Moreover, when ranking is done on-the-fly as in FIG. 4, the identified images can also be ranked using any of the following additional ranking factors:

### Weighting Text by Its Distance from an Image as a Ranking Factor.

Another ranking factor can be based on the distance that text within a search query is located on the same web page as an image, such that text that is closer to the image is associated more strongly than text that is further away from the image. The distance that text within a search query is from an image can be based on different distance elements. Distance elements may include the number of intervening words between the text and the image, number of intervening full stops such as “.” “?” “!” and other sentence-ending punctuation/symbols between the text and the image, number of intervening table data tags (<td>) between the text and the image, and the number of intervening table rows tags (<tr>) between the text and the image. An administrator may be able to configure this ranking factor to weigh each of the distance elements equally or differently. For example, the following is an exemplary formula for calculating the distance from an image to text within a search query that is located on the same web page as the image:

Distance=(1*numwords)+(10*numfullstops)+(5*numTDs)−(10*numTRs)

In the above formula, the number of intervening words (numwords) is multiplied by a weight factor of 1, the number of intervening full stops (numfullstops) is multiplied by a weight factor of 10, the number of intervening table data tags (numTDs) is multiplied by a weight factor of 5, and the number of intervening table row tags (numTRs) is multiplied by a weight factor of 10. With this ranking factor and with any of the other ranking factors described above in which a number value is calculated or determined in order to rank an image, the number value can be converted into a score “S” using a sigmoid function to further evaluate the ranking of images. With the present ranking factor, if the search query includes one or more words, the distance for each word can be converted into a score “S” and each of the scores can be summed in order to compute an overall score for the entire search query.

### Using Face and Name Detection as a Ranking Factor.

Another ranking factor can be based on whether an image includes a face of a person in it. For example, a conventional face detector 216 (FIG. 2) can be used to scan images stored in a database 208 (FIG. 2) in order to determine if images include one or more faces. In an embodiment, images with the greatest number of faces can be ranked higher than other images. In another embodiment, images with only one face can be ranked higher than images with no faces or with more than one face.

Additionally, the invention can be configured to evaluate whether the received search query is a request for an image of a person. In an embodiment, the invention can determine whether the search query is a request for an image of a person through use of a name detector 214 (FIG. 2). In an embodiment, the invention can use a name detector to determine that the search query is for an image of a person and images that include faces of people can be ranked higher than images that do not contain faces of people. In another embodiment, if the search query is does include a name, the invention can use the name detector to determine that the search query is not for an image of a person and images that contain faces may be ranked lower than images that do not contain faces.

While particular embodiments of the invention have been illustrated and described in detail herein, it should be understood that various changes and modifications might be made to the invention without departing from the scope and intent of the invention. The embodiments described herein are intended in all respects to be illustrative rather than restrictive. Alternate embodiments will become apparent to those skilled in the art to which the present invention pertains without departing from its scope.

From the foregoing it will be seen that this invention is one well adapted to attain all the ends and objects set forth above, together with other advantages, which are obvious and inherent to the system and method. It will be understood that certain features and sub-combinations are of utility and may be employed without reference to other features and sub-combinations. This is contemplated and within the scope of the appended claims.

We claim:

1. A method for providing images in a ranked order, comprising:
identifying at least one image on a web page of a website;
identifying at least one item of text associated with the at least one image on the web page;
associating the at least one image and the at least one item of text within a database; and
ranking the at least one image based on one or more ranking factors within the database, wherein at least one of the one or more ranking factors considers a link relationship between the at least one image and at least one other image.

2. The method according to claim 1, wherein the one or more ranking factors include a ranking factor that considers a number of websites that include an identical copy of the at least one image.

3. The method according to claim 1, wherein the one or more ranking factors include a ranking factor that considers a number of websites that include a similar version of the at least one image.

4. The method according to claim 1, wherein the one or more ranking factors include a ranking factor that considers an image size of the at least one image.

5. The method according to claim 1, wherein the one or more ranking factors include a ranking factor that considers the total number of links there are to the URL of the at least one image.

6. The method according to claim 1, wherein a first set of metadata associated with the at least one image is shared by each image having the link relationship.

7. The method according to claim 1, wherein the one or more ranking factors include a ranking factor that considers the frequency that the at least one image appears on the website.

8. A system for providing images in a ranked order, comprising:
an aggregation component for aggregating a plurality of images with corresponding text;
a name detector for detecting names within a search query;
a ranking component for ranking the aggregated images based on whether the name detector detects a name.

9. The system according to claim 8, further comprising a face detector.

10. The system according to claim 9, wherein images within the aggregated images that are detected by the face detector to include at least one face of a person are ranked higher when the name detector detects a name of a person within the search query.

11. The system according to claim 9, wherein images within the aggregated images that are detected by the face detector to include at least one face of a person are ranked lower or higher when the name detector does not detect a name of a person within the search query.

12. The system according to claim 8, wherein the ranking component further ranks the aggregated images based on at least one image feature.

13. The system according to claim 12, wherein the at least one image feature includes at least one of a number of pixels, an aspect ratio, an image file size, image entropy, and image gradient.

14. One or more computer-readable media having computer-usable instructions stored thereon for performing a method of providing images in a ranked order, the method comprising:
receiving a search query including at least one item of text;
identifying at least one image related to the search query;
ranking the at least one images using one or more ranking factors, wherein at least one of the one or more ranking factors considers a distance the at least one item of text is to the at least one image on a web page; and
providing the ranked one or more images.

15. The computer-readable media according to claim 14, further comprising converting the distance for each item of text within the search query to a preliminary score using a sigmoid function.

16. The computer-readable media according to claim 15, wherein the preliminary score for each item of text is summed in order to calculate an overall score.

17. The computer-readable media according to claim 14, wherein the distance is determined by considering one or more of a number of intervening words, symbols, and tags between the at least one item of text and the at least one image.

18. The computer-readable media according to claim 14, wherein the one or more ranking factors includes a ranking factor that considers whether the at least one image includes a face of a person.

19. The computer-readable media according to claim 14, wherein the one or more ranking factors includes a ranking factor that considers whether the search query includes a name of a person.

20. The computer-readable media according to claim 14, wherein the one or more ranking factors includes a ranking factor that considers the total number of images on the web page.
